(19) United States
(12) Patent Application Publication
(10) Pub. No.: US 2017/0086205 A1
(43) Pub. Date: Mar. 23, 2017

(54) SYSTEM AND METHOD FOR CLOUD SYNCHRONIZATION AMONG GLOBAL AND MULTIPLE LOCATION DATABASES

(71) Applicant: Nokia Technologies Oy, Espoo (FI)

(72) Inventor: Chittabrata Ghosh, Fremont (US)

(21) Appl. No.: 15/310,872

(22) PCT Filed: May 7, 2015
(86) PCT No.: PCT/FI2015/050309

§ 371 Date: Nov. 14, 2016

Related U.S. Application Data
(60) Provisional application No. 61/993,542, filed on May 15, 2014.

(51) Int. Cl. H04W 72/08; H04W 24/10; H04W 28/02; H04W 76/02

(52) U.S. Cl. CPC H04W 72/082; H04W 76/021; H04W 24/10; H04W 28/0236

(57) ABSTRACT

Systems, methods, apparatuses, and computer program products for synchronizing multiple LSA databases synchronously are provided. One method may include requesting a reporting period for a set of channels registered with at least one licensed shared access (LSA) database, and storing a list of the channels being used by the at least one LSA database and for storing an identifier of the at least one LSA database. The set of channels may comprise a preferred set of channels used by a communications network registered with the at least one LSA database.

### CROSS-REFERENCE TO RELATED APPLICATIONS

This application claims priority from U.S. Application No. 61/993,542, filed on May 15, 2014. The entire contents of this earlier filed application are hereby incorporated by reference in their entirety.

### BACKGROUND

Field

Certain embodiments generally relate to spectrum sharing between government radars and commercial communications systems, and may relate to synchronize multiple Licensed Shared Access (LSA) databases.

Description of the Related Art

Regulatory requirements prevent the use of a channel if radar has been detected. As a result, coexistence of Wi-Fi and radar seems to be forbidden by regulatory requirements. However, with a recent Presidential Council of Advisory for Science and Technology (PCAST) report, the military bands (S band) will be unleashed for secondary uses of communications systems (Wi-Fi and long term evolution (LTE)).

Based on this report, Defense Advanced Research Projects Agency (DARPA) has approved a recent project termed as Shared Spectrum Access of Radar Bands by Communications systems (SSPARC). SSPARC program seeks to improve radar and communications capabilities through spectrum sharing.

Spectrum sharing between radars and commercial communications systems, such as long term evolution (LTE), preserves radar capability while meeting needs for increased commercial communications spectrum without incurring the costs of relocating radars to new frequency bands.

### SUMMARY

One embodiment is directed to an apparatus that may include means for requesting a reporting period for a set of channels registered with at least one licensed shared access (LSA) database, and means for storing a list of the channels being used by the at least one LSA database and for storing an identifier of the at least one LSA database. The set of channels may comprise a preferred set of channels used by a communications network registered with the at least one LSA database.

According to some embodiments, the communications network may be a Long Term Evolution (LTE) network. In an embodiment, when the set of channels are likely to be used by government radar, the reporting period is made frequent.

According to certain embodiments, the apparatus may further include means for monitoring a level of interference on each channel being used by government radar at any point in time, and means for communicating, when the level of interference increases above a certain predetermined limit, the list of channels, which are imposing high interference, to a corresponding LSA database(s) identified by the LSA database identifier(s).

In one embodiment, the apparatus may also include means for immediately transmitting a reporting frame to the corresponding LSA databases with a request for ceasing operations.

Another embodiment is directed to an apparatus, which may include at least one processor and at least one memory comprising computer program code. The at least one memory and the computer program code are configured, with the at least one processor, to cause the apparatus at least to request a reporting period for a set of channels registered with at least one licensed shared access (LSA) database, and to store a list of the channels being used by the at least one LSA database and store an identifier of the at least one LSA database. The set of channels may comprise a preferred set of channels used by a communications network registered with the at least one LSA database.

According to some embodiments, the communications network may be a Long Term Evolution (LTE) network. In an embodiment, when the set of channels are likely to be used by government radar, the reporting period is made frequent.

According to certain embodiments, the at least one memory and the computer program code are further configured, with the at least one processor, to cause the apparatus at least to monitor a level of interference on each channel being used by government radar at any point in time, and to communicate, when the level of interference increases above a certain predetermined limit, the list of channels, which are imposing high interference, to a corresponding LSA database(s) identified by the LSA database identifier(s).

In one embodiment, the at least one memory and the computer program code are further configured, with the at least one processor, to cause the apparatus at least to immediately transmit a reporting frame to the corresponding LSA databases with a request for ceasing operations.

Another embodiment is directed to a method, which may include requesting a reporting period for a set of channels registered with at least one licensed shared access (LSA) database, and storing a list of the channels being used by the at least one LSA database and for storing an identifier of the at least one LSA database. The set of channels may comprise a preferred set of channels used by a communications network registered with the at least one LSA database.

According to some embodiments, the communications network may be a Long

Term Evolution (LTE) network. In an embodiment, when the set of channels are likely to be used by government radar, the reporting period is made frequent.

According to certain embodiments, the method may further include monitoring a level of interference on each channel being used by government radar at any point in time, and communicating, when the level of interference increases above a certain predetermined limit, the list of channels, which are imposing high interference, to a corresponding LSA database(s) identified by the LSA database identifier(s).

In one embodiment, the method may also include immediately transmitting a reporting frame to the corresponding LSA databases with a request for ceasing operations.

Another embodiment is directed to a computer program, embodied on a non-transitory computer readable medium. The computer program may be configured to control a processor to perform a process. The process may include requesting a reporting period for a set of channels registered with at least one licensed shared access (LSA) database, and storing a list of the channels being used by the at least one LSA database and for storing an identifier of the at least one LSA database. The set of channels may comprise a preferred set of channels used by a communications network registered with the at least one LSA database.

According to some embodiments, the communications network may be a Long Term Evolution (LTE) network. In an embodiment, when the set of channels are likely to be used by government radar, the reporting period is made frequent.

According to certain embodiments, the process may further include monitoring a level of interference on each channel being used by government radar at any point in time, and communicating, when the level of interference increases above a certain predetermined limit, the list of channels, which are imposing high interference, to a corresponding LSA database(s) identified by the LSA database identifier(s).

In one embodiment, the process may also include immediately transmitting a reporting frame to the corresponding LSA databases with a request for ceasing operations.

### BRIEF DESCRIPTION OF THE DRAWINGS

For proper understanding of the invention, reference should be made to the accompanying drawings, wherein:

FIG. 1 illustrates a system architecture for radar and communication system coexistence in radar bands, according to one embodiment;

FIG. 2 illustrates an apparatus according to an embodiment; and

FIG. 3 illustrates a flow diagram of a method according to an embodiment.

### DETAILED DESCRIPTION

It will be readily understood that the components of the invention, as generally described and illustrated in the figures herein, may be arranged and designed in a wide variety of different configurations. Thus, the following detailed description of the embodiments of systems, methods, apparatuses, and computer program products for synchronizing multiple LSA databases synchronously, as represented in the attached figures and described below, is not intended to limit the scope of the invention but is representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof

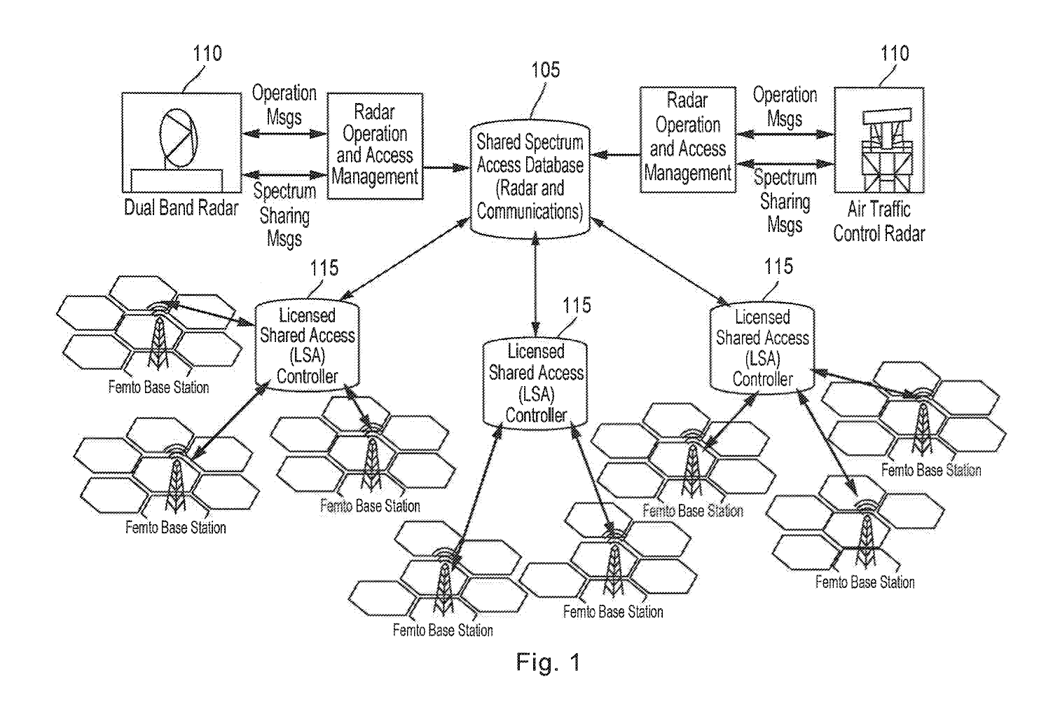

FIG. 1 illustrates a system architecture for radar and communication systems coexistence in radar bands. As illustrated in FIG. 1, there may be a global database termed as “Shared Spectrum Access Database” (SSAD) 105 that interacts with the radar incumbents 110. The information of radars is highly confidential and may not be shared with communication systems, such as LIE and wireless local area network (WLAN). Only authenticated sources from the communications side may be able to access partial information of radar usage in the S band (e.g., 2-4 GHz). These reliable sources are termed here as the Licensed Shared Access (LSA) Database 115 as illustrated in FIG. 1. Multiple such LSA databases 115 will access the SSAD 105 for coexistence.

Unlike the television (TV) white spaces where the database access was mandated by federal communications commission (FCC) for checking once every 24 hours, radar operation might change quite frequently, for example in 100s of msecs. This change of spectrum occupancy information needs to be shared between the hierarchical databases (LSA Controllers in FIG. 1) with minimal latency for reduced interference to sensitive radar detection. Without limitation, LSA database and LSA controller are used interchangeably.

In the presence of multiple LSA databases, there is a high probability that frames transmitted by two or more LSA databases might collide, and also the information distribution or percolation down among the hierarchical databases, which may result in latency issues. Therefore, embodiments provide a system, apparatus, and method to synchronize multiple LSA databases synchronously.

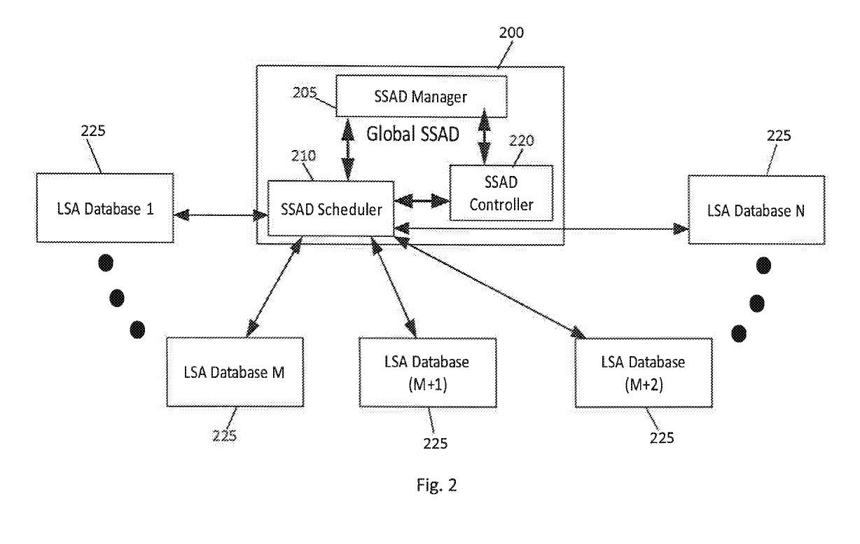

Certain embodiments provide an architecture within the global SSAD comprising a scheduler, a controller, and a manager. FIG. 2 illustrates an example of a block diagram for a synchronization scenario among a SSAD manager 205, SSAD scheduler 210, a SSAD controller 220, and LSA databases 225, according to one embodiment. In an embodiment, each LSA database 225 may be configured to authenticate itself in order to establish a secure connection with the SSAD scheduler 210. After establishment of a connection, each LSA database 225 declares its preferred set of channels. The preferred set of channels may be the set of channels that are used by LTE networks registered with one LSA Database or a LSA Controller. In other words, in an embodiment, operating channels of all the LTE networks under one LSA Controller constitute the “preferred set of channels.”

One embodiment provides a status reporting rule where, based on the set of channels used by the radars, the SSAD scheduler 210 requests a reporting period for the set of channels registered with each LSA database 225. In other words, in an embodiment, if the set of channels, for example a preferred set of channels, reported by an LSA database 225 are currently used or to be used in near future by the radar, this database 225 would be requested to report its preferred set of channels frequently. If the set of channels are not of interest for the military radars in the near future, the database 225 may be requested to report infrequently.

An embodiment also provides a rule for reduced imposed interference to radars. This embodiment provides a method of controlling interference imposed by LTE networks to military radars. This may be performed by the SSAD controller 220 in communication with the SSAD scheduler 210. The SSAD controller 220 may monitor the level of interference on each of the channels being used by the various military radars at any point of time. The list of channels being used along with the LSA database identifiers are maintained at the SSAD scheduler 210 and shared with the SSAD controller 220. If the level of interference in any one or set of the operating channels increases above a certain limit for a specific radar, the SSAD controller 220 may communicate that or the set of channels to the corresponding LSA databases 225 identified by the LSA database identifiers and their preferred list of channels that are imposing high interference. The SSAD scheduler 210 may immediately transmit a reporting frame to the corresponding LSA databases 225 with request for ceasing operation.

In an embodiment, the SSAD controller 220 may check the channels used by the radars registered with the SSAD scheduler 210. If the reported threshold (in terms of target detection range, that is, the maximum range to which a radar can detect a target) by the radar at the ROAM, which in turn shared with the SSAD scheduler 210, decreases by 5%, the SSAD scheduler 210 may deduce that the radar is experiencing interference on that operating channel. According to the Channel Set reported by each of the LSAs, the SSAD scheduler 210 may identify which of the LTE networks (under an LSA Controller) are interfering. There may be multiple LTE networks under multiple LSA Controllers operating on the same channel that impose interference to an operating radar.

In an embodiment, based at least on whether the interference for a channel exceeding a threshold, the SSAD scheduler 210 may tell LSAs to remove that channel from their channel set or using a reporting frame request the LSA Controller such that LTE networks operating on that affected channel may switch to a different channel.

In an embodiment, the radars report their detection range to ROAM (Radar Operation and Access Management) and then to the SSAD 105. The detection range is a function of probability of detection (PD) and probability of false alarms (PFA). If the PD is reduced by 5%, that is, the PD is 95% as reported by a radar to the ROAM and to the SSAD 105, the SSAD 105 may deduce that the radar is experiencing interference. In case the PD is less than 20%, the interference that the radar is experiencing is too high (not acceptable at all). In case the channel on which PD is detected to within 5%-20%, and the same channel is the operating one for an LTE network, then it can be deduced that the interference is due to the LTE network. Using a reporting frame, the SSAD may request a channel switch operation for LTE networks from the channel on which interference is experience by a radar.

In an embodiment, regarding interference at the LTE network, it is based on system throughput. If the system throughput reduces below 20% for an LTE network and it operates on the same channel as that of the radar, then the LSA 115 may deduce that the interference to the LTE network is due to the main beam of the radar, in the direction of the LTE network, is blasting full power towards the LTE network. The LSA 115 may use LTE interference measurements to determine whether radar interferes with LTE. The LSA 115 may report the interference to the SSAD 105, and the SSAD 105 may report it to ROAM. In an embodiment, the ROAM may inform the time of interference to the SSAD 105. That is, the ROAM may indicate the duration for which the radar stays on that main beam in that direction (during this duration, the LTE network will suffer interference from the radar). The SSAD 105 may send the duration information to the LSA 115. With this knowledge, the LTE network may decide either to evacuate to another channel or wait out the interference and continue on the same channel. The LTE network may not switch channel and not schedule resource blocks for the time indicated by the ROAM.

Another embodiment provides a rule for reduced interference to LTE. In this embodiment, the LSA databases 225 may also communicate with the SSAD scheduler 210 the levels of interference and channel numbers on which the LTE networks are experiencing high interference. This information is shared with the SSAD controller 220 for possible actions to be taken at the SSAD manager 205.

Thus, as illustrated in FIG. 2, the LSA databases 225 may communicate with the SSAD scheduler 210 in a definite schedule defined by the SSAD scheduler 210. The list of channels used by all the LSA databases 225 and their identifiers are passed on to the SSAD controller 220. Finally, the outcome of the SSAD controller 220 is shared with the SSAD manager 205 for actions to be taken in the military radars.

In view of the above, embodiments of the invention provide an apparatus 200 comprising SSAD manager 205, SSAD scheduler 210, and SSAD controller 220. In certain embodiments, SSAD manager 205, SSAD scheduler 210, and/or SSAD controller 220 may each comprise at least one processor, memory, and/or transceiver. Alternatively, in some embodiments, SSAD manager 205, SSAD scheduler 210, and/or SSAD controller 220 may share a processor, memory, and/or transceiver. The processor(s) may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

The memory, which may be internal or external and may be coupled to the processor(s), is configured to store information and instructions that may be executed by the processor(s). The memory may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, the memory may be comprised of any combination of random access memory (RAM), read only memory (ROM), static storage such as a magnetic or optical disk, or any other type of non-transitory machine or computer readable media. The instructions stored in the memory may include program instructions or computer program code that, when executed by the processor(s), enable the apparatus 200, as well as SSAD manager 205, SSAD scheduler 210, and/or SSAD controller 220, to perform tasks as described herein.

Apparatus 200 may also comprise or be coupled to one or more antennas (not shown) for transmitting and receiving signals and/or data to and from apparatus 200. Apparatus 200 may further comprise or be coupled to a transceiver (not shown) configured to transmit and receive information. The transceiver may be an external device, such as a remote radio head. For instance, transceiver may be configured to modulate information on to a carrier waveform for transmission by the antenna(s) and demodulate information received via the antenna(s) for further processing by other elements of apparatus 200. In other embodiments, the transceiver may be capable of transmitting and receiving signals or data directly.

As mentioned above, the processor(s) may perform functions associated with the operation of apparatus 200 including, without limitation, precoding of antenna gain/phase parameters, encoding and decoding of individual bits forming a communication message, formatting of information, and overall control of the apparatus 200, including processes related to management of communication resources.

In an embodiment, the memory may store software modules that provide functionality when executed by the processor. The modules may include, for example, an operating system that provides operating system functionality for apparatus 200. The memory may also store one or more functional modules, such as an application or program, to provide additional functionality for apparatus 200. The components of apparatus 200 may be implemented in hardware, or as any suitable combination of hardware and software.

According to an embodiment, SSAD scheduler 210 is configured to request a reporting period for a set of channels registered with at least one LSA database 225. In one embodiment, SSAD scheduler 210 is configured to store and/or maintain a list of channels being used by the at least one LSA database 225 and to store an identifier of the at least one LSA database 225. SSAD scheduler 210 may also be configured to share the list of channels and identifier(s) of the at least one LSA database 225 with the SSAD controller 220.

According to one embodiment, SSAD controller 220 may be configured to monitor a level of interference on each channel being used by government radar at any point in time. When the level of interference increases above a certain predetermined limit (determined by one of the several metrics, for example, PD), SSAD controller 220 may be configured to communicate the list of channels received from the SSAD scheduler 210 to the corresponding LSA databases 225 identified by the received LSA database identifier(s). In an embodiment, SSAD scheduler 210 may be configured to immediately transmit a reporting frame to the corresponding LSA databases 225 with a request for ceasing operations.

In some embodiments, SSAD scheduler 210 may be configured to receive, from LSA databases 225, levels of interference and channel numbers on which the networks (e.g., LTE network) are experiencing high interference. This information may be shared by the SSAD scheduler 210 with the SSAD controller 220 for possible action to be taken at the SSAD manager 205.

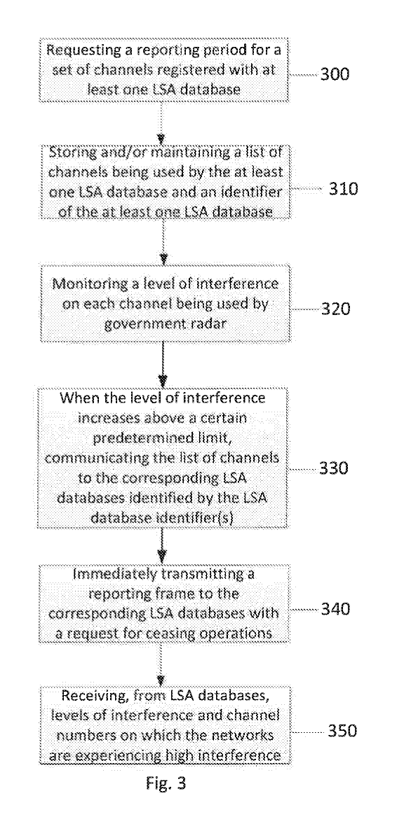

FIG. 3 illustrates a flow diagram of a method according to one embodiment of the invention. In one embodiment, the method may include, at 300, requesting a reporting period for a set of channels registered with at least one LSA database. In one embodiment, the method may further include, at 310, storing and/or maintaining a list of channels being used by the at least one LSA database and an identifier of the at least one LSA database. In some embodiments, the method may include, at 320, monitoring a level of interference on each channel being used by government radar at any point in time. When the level of interference increases above a certain predetermined limit, the method may further include, at 330, communicating the list of channels to the corresponding LSA databases identified by the LSA database identifier(s). In an embodiment, the method may also include, at 340, immediately transmitting a reporting frame to the corresponding LSA databases with a request for ceasing operations.

In some embodiments, the method may include, at 350, receiving, from LSA databases, levels of interference and channel numbers on which the networks (e.g., LTE network) are experiencing high interference. This information may be used for possible action to be taken at the SSAD manager.

In some embodiments, the functionality of any of the methods described herein, such as that of FIG. 3, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

In view of the above, embodiments of the invention can provide a coexistence mechanism for commercial communications systems, such as LTE, while cooperating with an operating radar on the same channel. With the recent acceptance of the Presidential Council of Advisory for Science and Technology (PCAST) vision, this shared spectrum solution is substantially beneficial for future wireless devices.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-15. (canceled)

16. An apparatus, comprising:
at least one processor; and
at least one memory including computer program code the at least one memory and the computer program code configured to, with the at least one processor, cause the apparatus to perform at least the following:
request a reporting period for a set of channels registered with at least one licensed shared access (LSA) database;
store a list of channels being used by each of the at least one LSA database respectively; and
store an identifier for each of the at least one LSA database;
wherein the set of channels comprises a preferred set of channels used by a communications network registered with the at least one LSA database.

17. The apparatus according to claim 16, wherein, when the set of channels are likely to be used by government radar, the reporting period is frequent.

18. The apparatus according to claim 16, the at least one memory and the computer program code are further configured, with the at least one processor, to cause the apparatus to perform:
monitor a level of interference on each of a plurality of channels used by government radar at any point in time;
in response to the level of interference of at least one of the plurality of channels increasing above a certain predetermined limit, communicate the at least one of the plurality of channels which are imposing high interference to the at least one LSA database identified by the respective-stored identifier.

19. The apparatus according to claim 18, wherein communicate the at least one of the plurality of channels which are imposing high interference to the at least one LSA database identified by the respective-stored identifier further comprises:
communicate the at least one of the plurality of channels which are imposing high interference corresponding to the stored list of channels being used by one of the at least one LSA database to the one of the at least one LSA database.

20. The apparatus according to claim 18, the at least one memory and the computer program code are further configured, with the at least one processor, to cause the apparatus to perform:
in response to the level of interference increasing above a certain predetermined limit, transmit a reporting frame to the corresponding LSA databases with a request for ceasing operations.

21. The apparatus according to claim 16, wherein the communications network comprises a Long Term Evolution (LTE) network.

22. A method, comprising:
requesting a reporting period for a set of channels registered with at least one licensed shared access (LSA) database;
storing a list of channels being used by each of the at least one LSA database respectively; and
storing an identifier of each of the at least one LSA database;
wherein the set of channels comprises a preferred set of channels used by a communications network registered with the at least one LSA database.

23. The method according to claim 22, wherein, when the set of channels are likely to be used by government radar, the reporting period is frequent.

24. The method according to claim 22, further comprising:
monitoring a level of interference on each of a plurality of channels used by government radar at any point in time;
monitoring a level of interference on each of a plurality of channels used by government radar at any point in time;
in response to the level of interference of at least one of the plurality of channels increasing above a certain predetermined limit, communicating the at least one of the plurality of channels which are imposing high interference to the at least one LSA database identified by the respective-stored identifier.

25. The method according to claim 24, wherein communicating the at least one of the plurality of channels which are imposing high interference to the at least one LSA database identified by the respective-stored identifier further comprises:
communicating the at least one of the plurality of channels which are imposing high interference corresponding to the stored list of channels being used by one of the at least one LSA database to the one of the at least one LSA database.

26. The method according to claim 24, further comprising:
in response to the level of interference increasing above a certain predetermined limit, transmitting a reporting frame to the corresponding LSA databases with a request for ceasing operations.

27. The method according to claim 22, wherein the communications network comprises a Long Term Evolution (LTE) network.

28. A computer program, embodied on a non-transitory computer readable medium, the computer program configured to control a processor to perform a process, comprising:
requesting a reporting period for a set of channels registered with at least one licensed shared access (LSA) database;
storing a list of channels being used by each of the at least one LSA database respectively; and
storing an identifier of each of the at least one LSA database;
wherein the set of channels comprises a preferred set of channels used by a communications network registered with the at least one LSA database.

29. The computer program according to claim 28, wherein, when the set of channels are likely to be used by government radar, the reporting period is frequent.

30. The computer program according to claim 28, further comprising:
monitoring a level of interference on each of a plurality of channels used by government radar at any point in time;
in response to the level of interference of at least one of the plurality of channels increasing above a certain predetermined limit, communicating the at least one of the plurality of channels which are imposing high interference to the at least one LSA database identified by the respective-stored identifier.

31. The computer program according to claim 30, wherein communicating the at least one of the plurality of channels which are imposing high interference to the at least one LSA database identified by the respective-stored identifier further comprises:
communicating the at least one of the plurality of channels which are imposing high interference corresponding to the stored list of channels being used by one of the at least one LSA database to the one of the at least one LSA database.

32. The computer program according to claim 30, further comprising:
in response to the level of interference increasing above a certain predetermined limit, transmitting a reporting frame to the corresponding LSA databases with a request for ceasing operations.

33. The computer program according to claim 28, wherein the communications network comprises a Long Term Evolution (LTE) network.
